(19) United States
(12) Patent Application Publication
(10) Pub. No.: US 2012/0160987 A1
(43) Pub. Date: Jun. 28, 2012

(54) WINCH MOUNT

(76) Inventor: Gregory A. Brown, Fort McMurray (CA)

(21) Appl. No.: 13/021,154

(22) Filed: Feb. 4, 2011

(30) Foreign Application Priority Data
Dec. 23, 2010 (CA) 2726717

(51) Int. Cl. B60R 11/06; B66D 1/28

(52) U.S. Cl. 248/676

(57) ABSTRACT

A mount for supporting a winch or for supporting a pulley for a winch. The mount is attached to a truck in the cargo area of the truck. An upright element supports the pulley or winch and is attached in the front of the cargo area to support the pulley or winch above the front of the cargo area. Support arms attached in the rear of the cargo area support the upright element. The mount can be folded by detaching the support arms and pivoting the upright element to rest in the cargo area of the truck.

### CROSS-REFERENCE TO RELATED APPLICATIONS

This application claims the benefit under 35 USC 119 of Canadian non-provisional application serial no. 2,726,717 filed Dec. 23, 2010.

### TECHNICAL FIELD

Mounts for winches on vehicles.

### BACKGROUND

There is a need for a sturdy mount for a winch to haul moose, or other large and heavy objects, into the back of a truck, such as for example a pickup truck. The mount should preferably interfere as little as possible with the cargo space of the pickup truck when deployed and be foldable or easily disassembled when not in use.

### SUMMARY

In order to meet at least one of the above objectives, a mount for a winch is provided for deployment on a truck having a cargo bed, the mount having an upright element for placement on the cargo bed of the truck in the front of the cargo bed, the upright element having a mounting area for mounting a winch or a pulley, one or more rear mounting pads for attachment to the truck at a location in the rear of the cargo bed of the truck, one or more front mounting pads for attachment to the truck at a location in the front of the cargo bed of the truck, at least a pivot element for pivotably connecting the upright element to the one or more front mounting pads, a left support arm, a first connector to connect the left support arm to the upright element to support the upright element, a second connector to connect the left support arm to at least one of the one or more rear mounting pads, a right support arm, a third connector to connect the right support arm to the upright element to support the upright element, and a fourth connector to connect the right support arm to at least one of the one or more rear mounting pads.

Each of the first connector, second connector, third connector and fourth connector may connect removably or rotatably or both removably or rotatably. One or both of the first connector and second connector may connect removably, and one or both of the third connector and fourth connector may connect removably. The front mounting pads and the rear mounting pads may be attached to the frame of the truck for a secure connection to the truck.

The first connector and the third connectors may be pin joints, and the second connector and the fourth connectors may be ball joints. The second and fourth connectors may be ball joints in which the one or more rear mounting pads have trailer hitch balls to which the left and right support arms attach.

The left and right support arms, when attached to the upright element, may bow outwards from each other to increase cargo space. The left and right support arms may be telescoping poles.

These and other aspects of the device are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic diagram of a winch mount viewed from above;

FIG. 2 is a schematic diagram of the winch mount of FIG. 1 viewed from the rear;

FIG. 3 is a schematic diagram of the winch mount of FIG. 1 viewed from the side;

FIG. 4 is a schematic diagram of the winch mount of FIG. 1 mounted in a pickup truck viewed from the side;

FIG. 5 is a schematic diagram of the winch mount of FIG. 1 in a folded position viewed from above;

FIG. 6 is a schematic diagram of the winch mount of FIG. 1 in a folded position viewed from the side;

FIG. 7 is a diagram of a upright element of a winch mount, viewed from the front;

FIG. 8 is a close up side view of a connection on the upright element of FIG. 7 to connect to the support arm of FIG. 11;

FIG. 9 is a top view of a front mounting pad for mounting the upright element of FIG. 7;

FIG. 10 is a top view of a rear mounting pad for mounting the support arm of FIGS. 11; and

FIG. 11 is a side view of a support arm for supporting the upright element of FIG. 7.

### DETAILED DESCRIPTION

Immaterial modifications may be made to the embodiments described here without departing from what is covered by the claims.

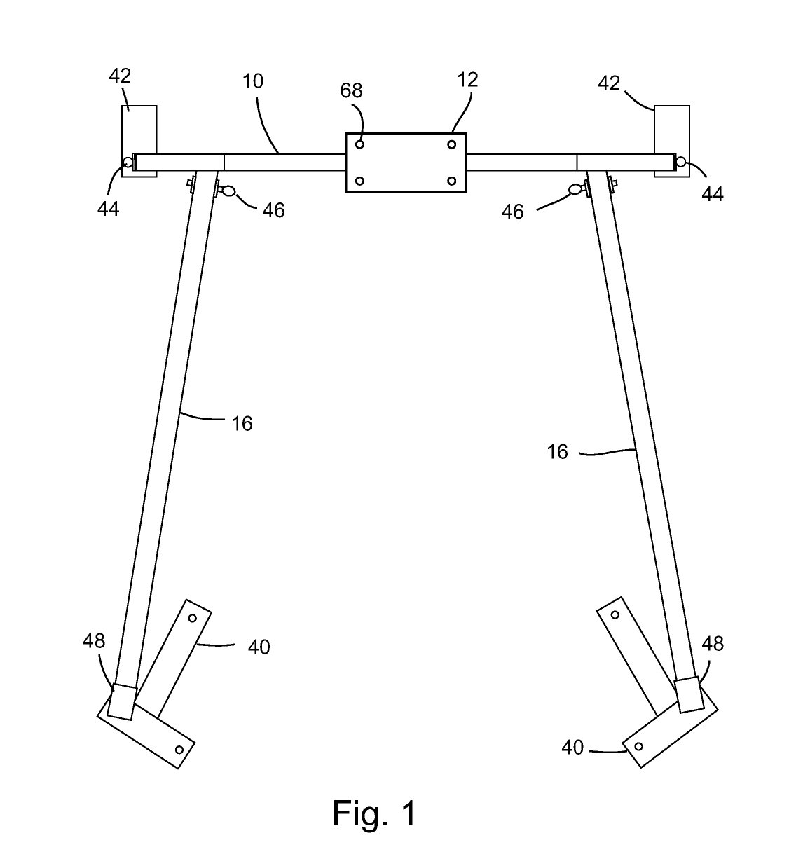

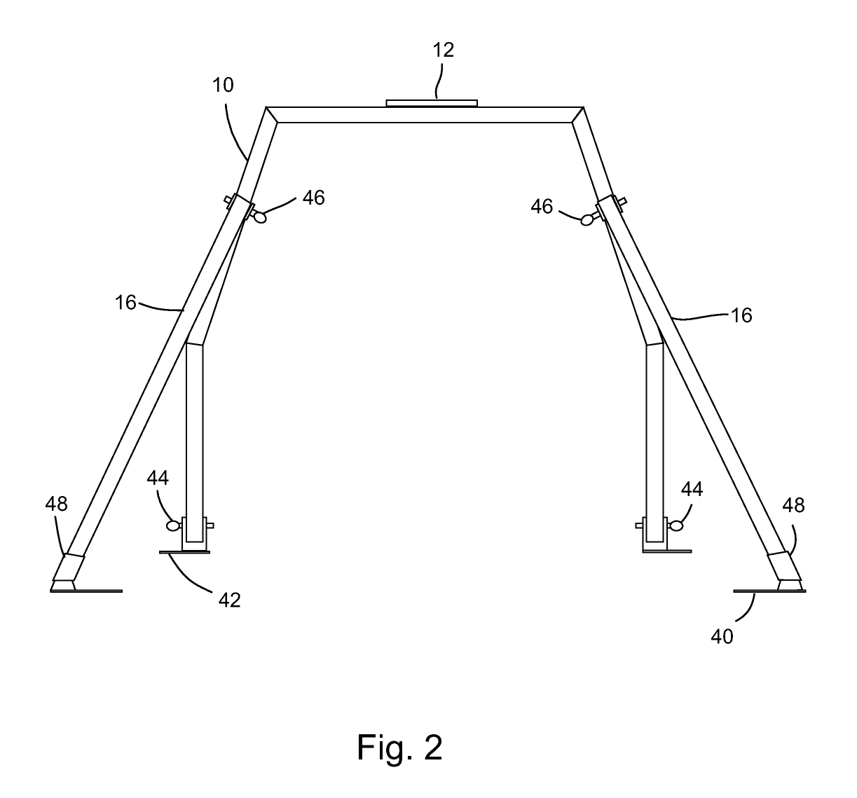

FIGS. 1-3 show a winch mount of an embodiment of the present invention. FIGS. 1-3 are not to scale so relative dimensions are not necessarily consistent between the figures.

Referring to FIGS. 1-3, a winch mount comprises an upright element 10 having a mounting area for mounting a winch. The mounting area may be a plate 12 welded to the top of the upright element. The plate may have bolt holes 68 to bolt a winch onto the plate. The bolt holes may be placed or sized differently to accommodate a winch of a particular size or make to be bolted to the plate. The upright element may be supported by left and right support arms 16. The support arms 16 may be connected to rear mounting pads 40 attached to a truck. The mounting pads may be attached to the frame of the truck for a secure connection. The connections between the rear mounting pads and the support arms and between the support arms and the upright element may be releasable and rotatable. The upright element may also be pivotably connected to front mounting pads 42 so that the upright element may be pivoted into a horizontal position for folding the winch mount. The front mounting pads may be attached to the frame of the truck for a secure connection. The front mounting pads may be a single mounting pad extending to connect to two legs of the upright element, as shown in FIG. 9. The upright element may be connected to the front mounting pads with lower pivot pins 44, and to the support arms with upper pivot pins 46. The support arms may be connected to the rear mounting pads using ball joints, such as a trailer hitch ball and trailer connector 48 for connecting to a trailer hitch ball. The mount can be set away from the front edge of the cargo bed to allow for the use of a folding or roll away tonnage cover (not shown) that would protect the mount and its attached winch when in the folded down position from the elements and any would be thieves.

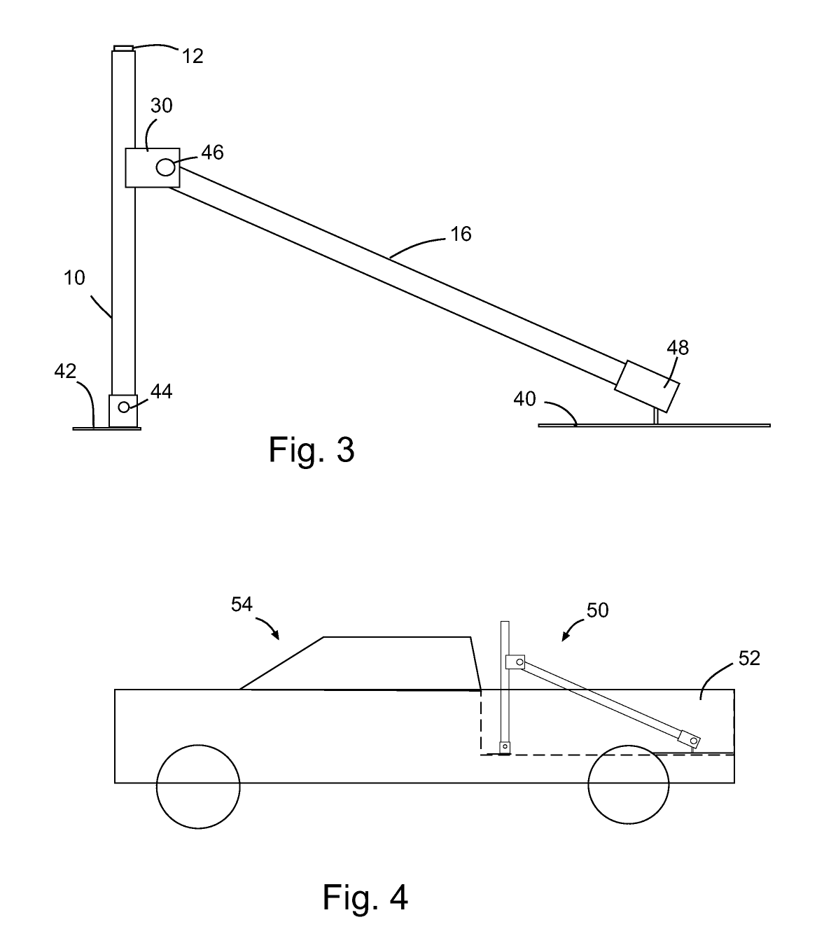

Referring to FIG. 4, a winch mount as shown in FIG. 3 is shown in the context of a pickup truck. The winch mount 50 is placed in the cargo area 52 of a pickup truck 54 in order for a winch attached to the winch mount to be used to haul objects into the cargo area of the truck.

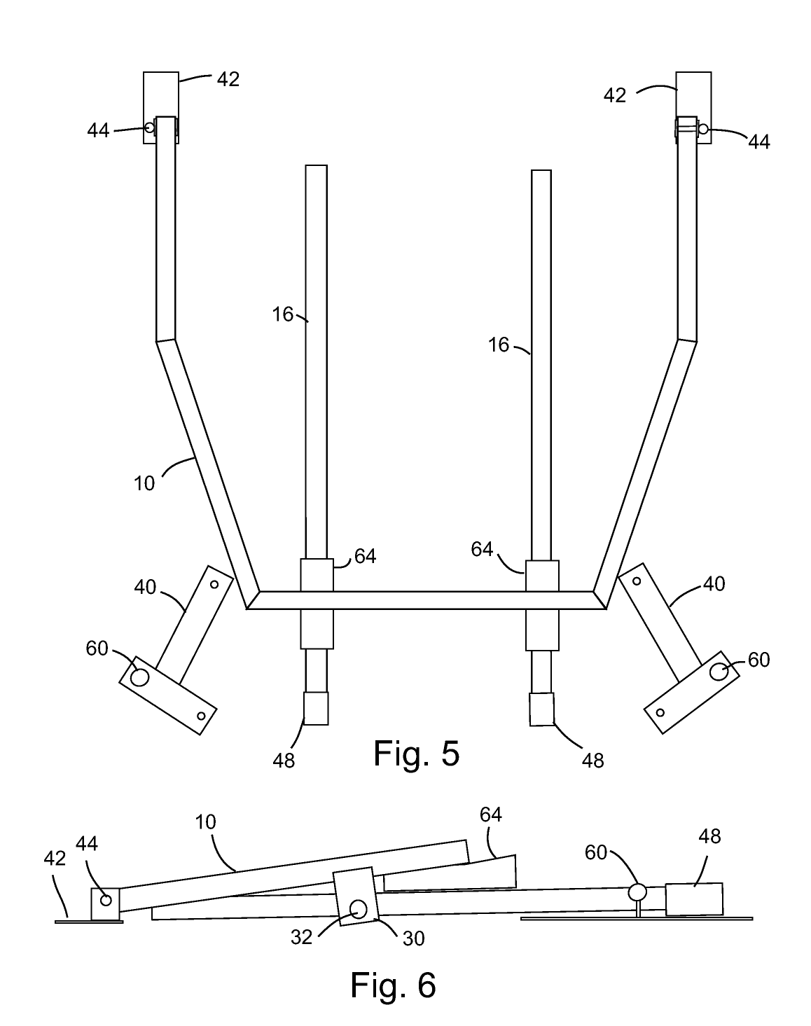

Referring to FIG. 5 and FIG. 6 the winch mount of FIGS. 1-3 is shown in a folded position from above and from the side respectively. In the folded position in this embodiment the support arms are detached and the upright element is pivoted into a substantially horizontal position. The support arms may be placed on the cargo bed of the truck and the upright element may be supported in the substantially horizontal position by pads 64 placed on the support arms.

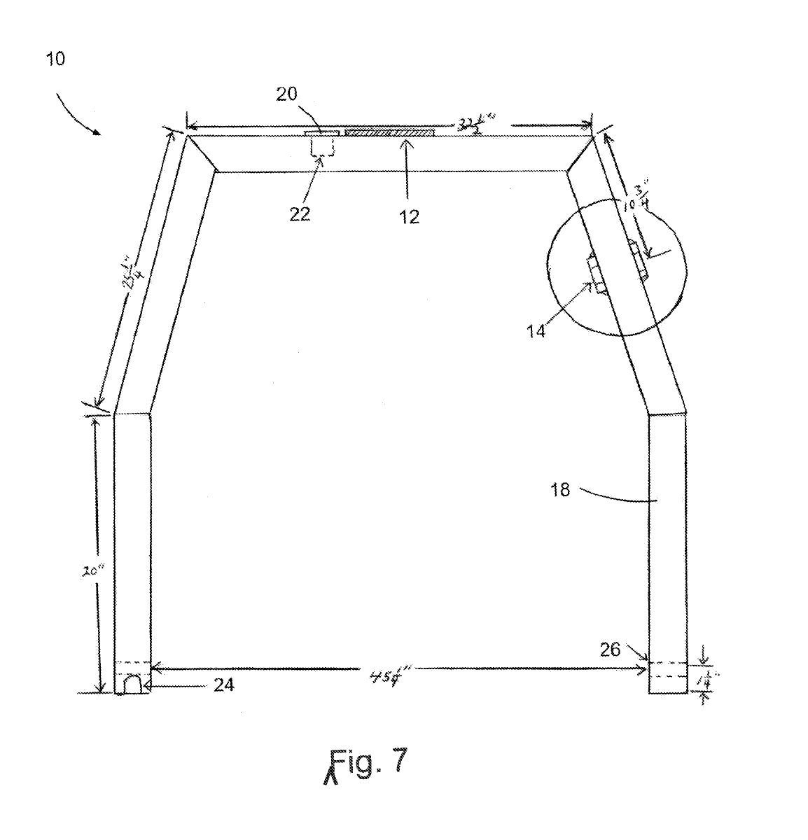

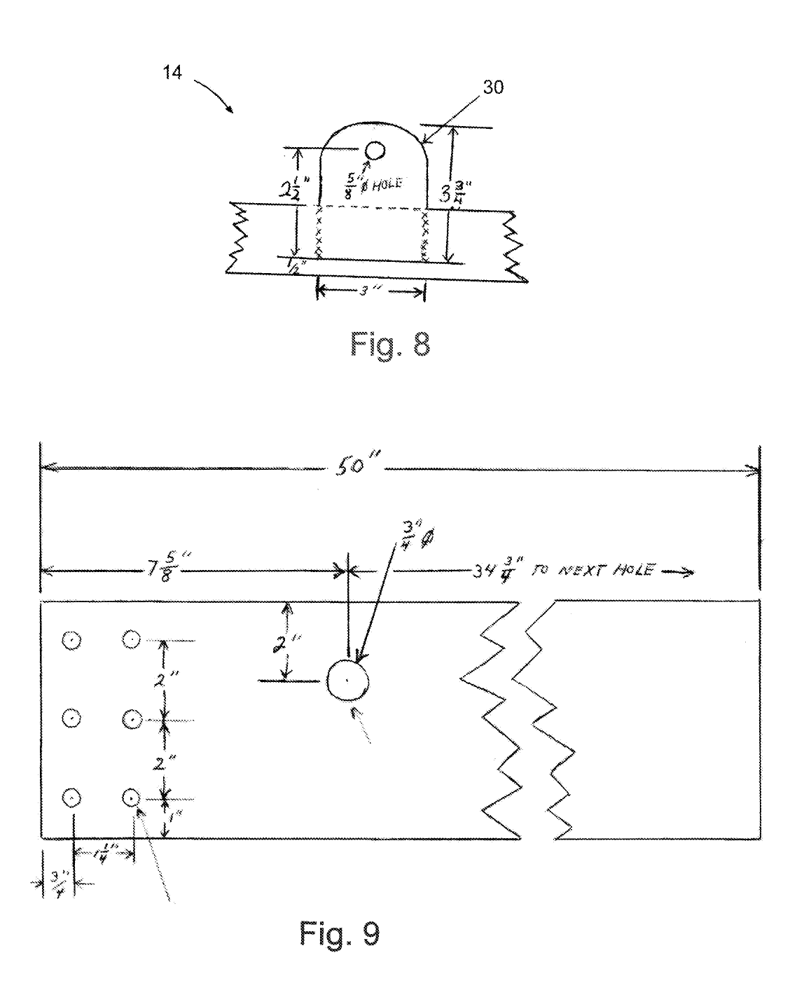

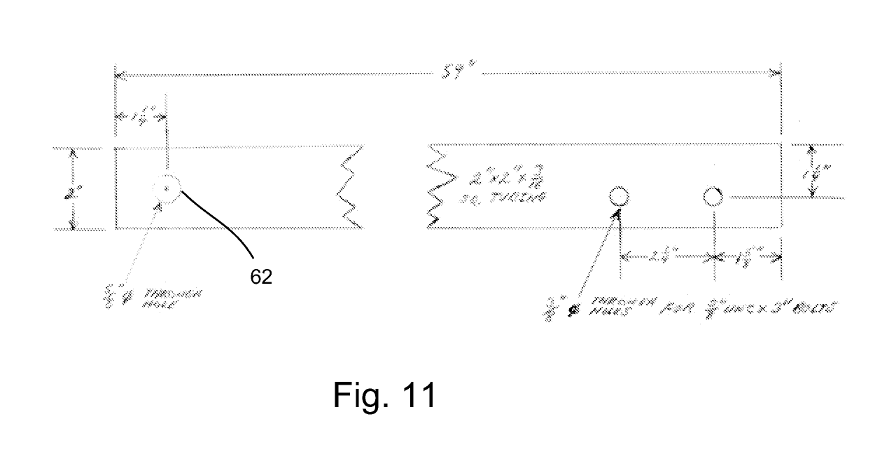

FIGS. 7-10 show components of an embodiment of the present invention in more detail. Referring to FIG. 7, a upright element 10 is shown. The upright element has a mounting area for mounting a winch, in this embodiment a winch adaptor plate 12 welded onto the top of the upright element. A connection element 14, shown in more detail in FIG. 8, allows a support arm 16, shown in FIG. 11, to connect to the upright element to support it. The embodiment has a second connection element disposed symmetrically to the connection element shown, but only one of the connection elements is shown in the figure. In the embodiment shown, the upright element is constructed from 2″×2″× 3/16 square tubing 18. The upright element may have a hole 20 near the mounting area to enable electrical wires to connect to the winch through the upright element. The hole 20 may have a rubber insert 22 allowing electrical wires to enter the upright element through the rubber insert but preventing water or other extraneous material from entering the upright element through the hole. The upright element may have a further hole or cut away portion 24 near the bottom to enable electrical wires to connect to the winch through the lower hole 24, through the upright element and through the upper hole 20. In this embodiment there are also holes 26 through each leg of the upright element for receiving pivot pins, aligned to pivot together.

Referring to FIG. 8, a connection element 14 of the embodiment of FIG. 7 is shown. The connection element 14 in this embodiment comprises a pair of plates 30 welded to the upright element, each plate having a hole 32, the holes 32 being aligned to receive a pivot pin.

Referring to FIG. 9, a front mounting pad is shown for attachment to the frame of a truck. In this embodiment, attachments (not shown) for lower pivot pins 44 are attached to each end of the front mounting pad to pivotably support left and right legs of the upright element 10.

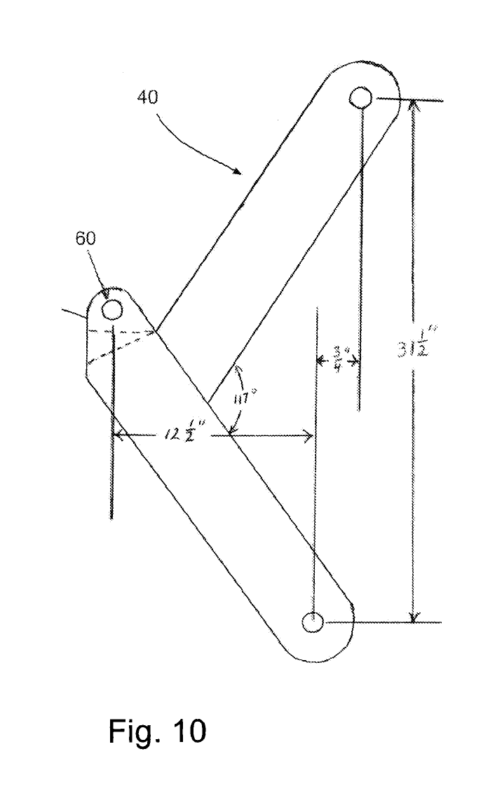

Referring to FIG. 10, a rear mounting pad 40 is shown for removably supporting a support arm 16. The rear mounting pad is designed to be attached to the frame of the truck for a strong connection. The rear mounting pad in this embodiment has a ball such as a trailer hitch ball 60 for the support arm to removably attach to. The ball may be on a portion 66 of the rear mounting pad angled away from the floor of the cargo area of the truck to match the orientation of the corresponding support arm, for example approximately 45 degrees.

Referring to FIG. 11, a support arm is shown. The support arm can removably attach to the upright element and to the rear mounting pad. In this embodiment the support arm has a transverse hole 62 at one end to receive a pivot pin 46 to connect it to the connection element 14, and at the other end has a trailer connector (not shown in FIG. 11, but shown as 48 in other figures) for receiving the trailer hitch ball 60 of the rear mounting pad 40.

In an embodiment, the support arms may be telescopic in order to adapt the winch mount to fit on a wider variety of trucks. In use, the winch mount supports a winch for pulling objects into the cargo area of the truck. A ramp may be used to facilitate pulling objects from the ground into the cargo area. A ramp such as drag rails may be provided with the winch mount, or other ramps such as a temporary plywood ramp may be used. In an embodiment, the winch could be located at a location other than the upright element, such as on a front mounting pad, and pull objects into the cargo area using a pulley or pulleys on the upright element. The support arms may bow out from each other when connected to the upright element to reduce the impact of the mount on cargo space in the cargo area of the truck.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A mount for a winch or pulley for deployment on a truck having a cargo bed, comprising:
an upright element for placement on the cargo bed of the truck in the front of the cargo bed, the upright element having a mounting area for mounting a winch or a pulley;
one or more rear mounting pads for attachment to the truck at a location in the rear of the cargo bed of the truck;
one or more front mounting pads for attachment to the truck at a location in the front of the cargo bed of the truck;
at least a pivot element for pivotably connecting the upright element to the one or more front mounting pads;
a left support arm;
a first connector to connect the left support arm to the upright element to support the upright element;
a second connector to connect the left support arm to at least one of the one or more rear mounting pads;
a right support arm;
a third connector to connect the right support arm to the upright element to support the upright element; and
a fourth connector to connect the right support arm to at least one of the one or more rear mounting pads.

2. The mount of claim 1 in which each of the first connector, second connector, third connector and fourth connector connects removably or rotatably or both removably or rotatably.

3. The mount of claim 1 in which at least one of the first connector and second connector connects removably, and at least one of the third connector and fourth connector connects removably.

4. The mount of claim 1 in which the one or more front mounting pads are attached to the frame of the truck.

5. The mount of claim 1 in which the one or more rear mounting pads are attached to the frame of the truck.

6. The mount of claim 1 in which the first connector and the third connector are pin joints.

7. The mount of claim 1 in which the second connector and the fourth connector are ball joints.

8. The mount of claim 7 in which the one or more rear mounting pads have trailer hitch balls to which the left and right support arms attach.

9. The mount of claim 1 in which the left and right support arms, when attached to the upright element, bow outwards from each other.

10. The mount of claim 1 in which the left and right support arms are telescoping poles.
